(19) United States
(12) Patent Application Publication
(10) Pub. No.: US 2013/0024394 A1
(43) Pub. Date: Jan. 24, 2013

(54) SERVER APPARATUS, REACTION TRANSMITTING PROGRAM, RECORDING MEDIUM HAVING COMPUTER-READABLE REACTION TRANSMITTING PROGRAM RECORDED THEREON, TERMINAL DEVICE, REACTION COUNTING METHOD, AND REACTION COUNTING SYSTEM

(71) Applicant: Hisanori Yamahara, Shinagawa-ku (JP)

(72) Inventor: Hisanori Yamahara, Shinagawa-ku (JP)

(73) Assignee: RAKUTEN, INC., Shinagawa-ku, Tokyo (JP)

(21) Appl. No.: 13/637,554

(22) PCT Filed: Mar. 30, 2011
(86) PCT No.: PCT/JP2011/058113

§ 371 Date: Sep. 26, 2012

(30) Foreign Application Priority Data
Mar. 31, 2010 (JP) 2010-081994

(51) Int. Cl. G06Q 30/00

(52) U.S. Cl. 705/347

(57) ABSTRACT

The present invention provides, for example, a server apparatus which can learn a reaction related to information by a user who the information is offered. A reaction of the user related to offer information offered by a webpage and a URL of the webpage are received from a terminal device, the reaction of the user and the URL are associated and stored in a memory means, and the reaction of the user is counted per URL.

### TECHNICAL FIELD

The present invention relates to a technical field of counting reactions to a webpage.

### BACKGROUND ART

Conventionally, a technique related to an information offering apparatus which offers information to a user terminal which requests an offer of information (for example, see Patent Literature 1).

### CITATION LIST

### Patent Literature

Patent Literature 1: Japanese Patent Application Laid-Open No. 9-167130

### SUMMARY OF THE INVENTION

### Problem to be Solved by the Invention

However, a conventional information offering apparatus unilaterally offers information to a user terminal which requests an offer of information. By contrast with this, it is difficult to learn a reaction to information offered by a user.

The present invention is made in light of this problem, and an example of an object of the present invention is to provide a server apparatus, a reaction transmitting program, a recording medium having a computer-readable reaction transmitting program recorded thereon, a terminal device, a reaction counting method and a reaction counting system which realize learning a reaction related to information by a user who the information is offered.

### Means for Solving the Problem

In order to solve the above problem, an invention described in claim 1 is a server apparatus that is connected to a terminal device through a network, the server apparatus comprising: a receiving means that receives from the terminal device a reaction of a user related to offer information offered by a webpage and a URL of the webpage; a memory means that associates and stores the reaction of the user received by the receiving means and the URL; and a counting means that counts the reaction of the user stored in the memory means per URL.

According to the present invention, it is possible to learn a reaction of a user related to offer information offered by a webpage.

An invention described in claim 2 is the server apparatus according to claim 1, wherein a tool bar program of acquiring the reaction of the user related to the offer information offered by the webpage and the URL of the webpage and associating and transmitting the reaction and the URL is installed in the terminal device, and the receiving means receives the reaction of the user related to the offer information offered by the webpage and the URL of the webpage, the reaction and the URL being transmitted by the tool bar program.

An invention described in claim 3 is the server apparatus according to claim 2, further comprising a response receiving means that makes an inquiry about use of the reaction inputted by the user, to the user by means of the tool bar program installed in the terminal device, and receives a response to the inquiry inputted by the user.

An invention described in claim 4 is the server apparatus according to any one of claims 1 to 3, wherein the reaction of the user is an evaluation of the user.

An invention described in claim 5 is the server apparatus according to claim 4, wherein the receiving means further receives a search condition transmitted from the terminal device, and the server apparatus further comprises: a searching means that searches for a webpage which satisfies the search condition received by the receiving means; a URL specifying means that specifies the URL stored in the memory means together with the evaluation of the user from URLs of webpages searched by the searching means; an evaluation rank determining means that determines for the URL specified by the URL specifying means an evaluation rank based on the evaluation of the user counted by the counting means; and an offering means that offers to the terminal device which has transmitted the search condition at least the URL specified by the URL specifying means according to the evaluation rank determined by the evaluation rank determining means.

According to the present invention, a user who searches for a webpage can check a URL of the searched webpage in an order based on a user's evaluation.

An invention described in claim 6 is the server apparatus according to claim 4 or 5, further comprising: a webpage generating means that generates a webpage offering offer information related to a specific target; and an acquiring means that acquires from the memory means the evaluation of the user associated with the URL of the webpage offering offer information related to an identical target as the specific target, wherein the webpage generating means generates a webpage including the evaluation of the user acquired from the acquiring means.

According to the present invention, it is possible to include an evaluation on a target in webpage which offers offer information related to the same target, in the webpage which offers offer information related to a specific target. Consequently, the user can check the evaluation on the same target in various webpages through one webpage.

An invention described in claim 7 is the server apparatus according to any one of claims 4 to 6, wherein the evaluation of the user is one of an evaluation based on a comment and a multilevel evaluation.

According to the present invention, it is possible to acquire at least one of an evaluation based on a user's comment and a multilevel evaluation.

An invention described in claim 8 is the server apparatus according to claim 7, wherein the multilevel evaluation is an evaluation on a plurality of items defined based on the offer information.

According to the present invention, it is possible to acquire a user's multilevel evaluation on a plurality of items.

An invention described in claim 9 is the server apparatus according to claim 8, wherein the receiving means further receives one of the URL of the webpage read by the terminal device and a META tag described in the webpage, and the server apparatus further comprises an item defining means that specifies a genre to which a target of offer information offered by the webpage belongs, based on at least one of the URL or the META tag received by the receiving means, and defines the plurality of items based on the specified genre.

According to the present invention, it is possible to define items of a user's multilevel evaluation without bothering the user.

An invention described in claim 10 is a reaction transmitting program causing a computer to function as: a reaction acquiring means that acquires a reaction of a user related to offer information offered by a webpage displayed on a display unit; a URL acquiring means that acquires a URL of the webpage; and a reaction transmitting means that associates and transmits to a server apparatus the reaction of the user acquired by the reaction acquiring means and the URL acquired by the URL acquiring means.

An invention described in claim 11 is a terminal device comprising: a webpage displays means that displays a webpage on a display unit; a reaction acquiring means that acquires a reaction of a user related to offer information offered by a webpage displayed on a display unit; a URL acquiring means that acquires a URL of the webpage; and a reaction transmitting means that associates and transmits to a server apparatus the reaction of the user acquired by the reaction acquiring means and the URL acquired by the URL acquiring means.

An invention described in claim 12 is a reaction counting method comprising: a receiving step of, at a computer, receiving from a terminal device a reaction of a user related to offer information offered by a webpage and a URL of the webpage; a storing step of, at the computer, associating and storing the received reaction of the user and the URL in a memory means; and a counting step of, at the computer, counting the reaction of the user stored in the memory means per URL.

An invention described in claim 13 is a reaction counting system that comprises a terminal device and a server apparatus that is connected to the terminal device through a network, wherein the server apparatus comprises: a receiving means that receives from the terminal device a reaction of a user related to offer information offered by a webpage and a URL of the webpage; a memory means that associates and stores the reaction of the user received by the receiving means and the URL; and a counting means that counts the reaction of the user stored in the memory means per URL, and the terminal device comprises: a webpage displays means that displays the webpage on a display unit; a reaction acquiring means that acquires the reaction of the user related to the offer information offered by the webpage displayed on a display unit; a URL acquiring means that acquires the URL of the webpage; and a reaction transmitting means that associates and transmits to the server apparatus the reaction of the user acquired by the reaction acquiring means and the URL acquired by the URL acquiring means.

An invention described in claim 14 is a recording medium having a computer-readable reaction transmitting program recorded thereon which causes a computer to function as: a reaction acquiring means that acquires a reaction of a user related to offer information offered by a webpage displayed on a display unit; a URL acquiring means that acquires a URL of the webpage; and a reaction transmitting means that associates and transmits to a server apparatus the reaction of the user acquired by the reaction acquiring means and the URL acquired by the URL acquiring means.

### Effect of the Invention

According to the present invention, it is possible to learn users' reactions related to offer information offered by a webpage.

### BRIEF DESCRIPTION OF THE DRAWINGS

FIG. 1 is a view that illustrates an example of a configuration of an evaluation information utilizing system according to an embodiment.

FIG. 2 is a block diagram that illustrates an example of a configuration of a server according to an embodiment.

FIG. 3 is a block diagram that illustrates an example of a configuration of a user terminal according to an embodiment.

FIG. 4 is a view that illustrates a screen example when an evaluation is inputted according to an embodiment.

FIG. 5 is a view that illustrates an operation example of the evaluation information utilizing system when an evaluation is registered according to an embodiment.

FIG. 6 is a view that illustrates an example of a search result page according to an embodiment.

FIG. 7 is a view that illustrates an operation example of an evaluation information utilizing system upon search according to an embodiment.

FIG. 8 is a view that illustrates a screen example when an evaluated webpage is displayed according to an embodiment.

FIG. 9 is a view that illustrates an operation example of an evaluation information utilizing system when an evaluation is registered according to an embodiment.

FIG. 10 is a view that illustrates an example of an evaluation input form according to an embodiment, and FIG. 10(a) illustrates an example of a first evaluation input form and FIG. 10(b) illustrates an example of a second evaluation input form.

FIG. 11 is a view that illustrates an operation example of an evaluation information utilizing system when an evaluated webpage is displayed according to an embodiment.

FIG. 12 is a view that illustrates an example of an inquiry form.

### MODES FOR CARRYING OUT THE INVENTION

Hereinafter, embodiments of the present invention will be described with reference to the drawings. In addition, embodiments will be described below where the present invention is applied to an evaluation information utilizing system.

### 1. First Embodiment

[1.1 Outline of Configuration and Function of Evaluation Information Utilizing System]

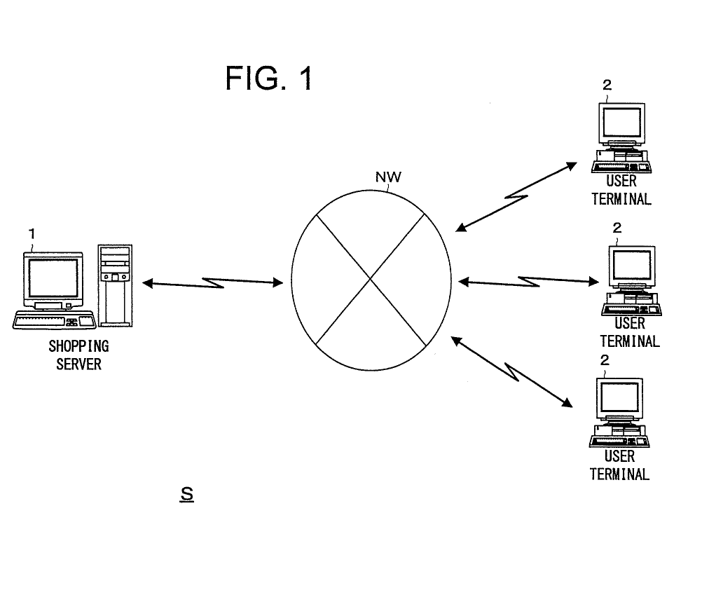

First, a configuration and a schematic function of an evaluation information utilizing system S according to a first embodiment of the present invention will be described using FIG. 1.

As illustrated in FIG. 1, the evaluation information utilizing system S (an example of a “reaction counting system”) has a server 1 (an example of a “server apparatus”) and a plurality of user terminals 2 (an example of a “terminal device”) used by users.

The server 1 and the user terminals 2 can transmit and receive data to and from each other through a network NW using, for example, TCP/IP for a communication protocol. In addition, the network NE is constructed with, for example, Internet, a dedicated communication line (for example, CATV (Community Antenna Television) line), a mobile communication network (including, for example, base stations) and a gateway.

The server 1 distributes to the user terminals 2 a tool bar program (hereinafter, a “tool bar”. An example of a “reaction transmitting program”) used to use a function of the evaluation information utilizing system S. The tool bar is a program for expanding a function of a web browser program (hereinafter, a “web browser”) installed in the user terminals 2, and is a sort of so-called plug-in. A user of the user terminal 2 can input an evaluation on a webpage displayed on the web browser using the tool bar. When receiving an input of the evaluation from the user, the user terminal 2 transmits to the server 1 evaluation data associating the evaluation on the webpage and a URL of a webpage which is an evaluation target by means of the function of the tool bar. When receiving the evaluation data, the server 1 associates and registers the evaluation and the URL in an evaluation DB (Data Base). Further, the server 1 offers various services using the evaluation registered in the evaluation DB. In addition, an evaluation on a webpage is an evaluation on offer information offered by the webpage. That is, a user's evaluation on a webpage is an example of “a user's reaction related to offer information offered by a webpage”.

[1.2. Configuration of Server 1]

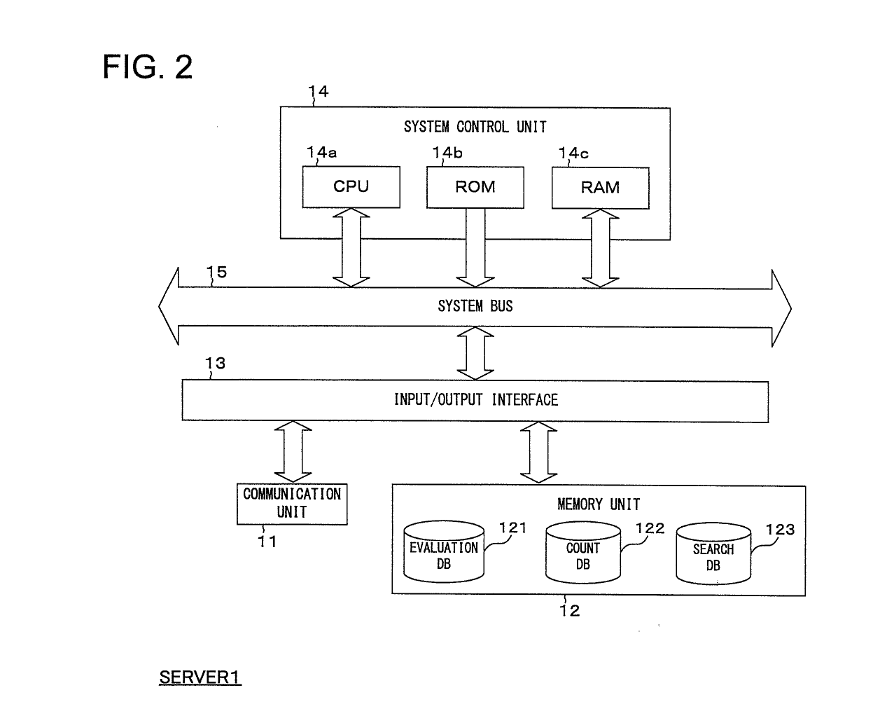

Next, the configuration of the server 1 will be described using FIG. 2.

As illustrated in FIG. 2, the server 1 has a communication unit 11, a memory unit 12, an input/output interface 13 and a system control unit 14. Further, the system control unit 14 and the input/output interface 13 are connected through a system bus 15.

The communication unit 11 connects to the network NW to control a communication state with the user terminals 2.

The memory unit 12 is configured to include, for example, a hard disk drive. Further, in the memory unit 12, an evaluation DB 121, a count DB 122 and a search DB 123 are constructed.

In the evaluation DB 121 (an example of a “memory means”), a user's evaluation and a URL included in evaluation data received from the user terminal 2 are associated and registered. A method of evaluating a webpage according to the present embodiment includes two types of an evaluation based on a comment and a 5 level evaluation (an example of a “multilevel evaluation”). With the present embodiment, an evaluation input form which will be described below and which allows users to perform at least one of evaluations is prepared. According to the 5 level evaluation, the user can select one of 1 point to 5 points as an evaluation point. The evaluation DB 121 is configured such that these two types of evaluations can be registered.

In the count DB 122, an average value of evaluation points and the number of evaluations are registered per URL registered in the evaluation DB 121.

In the search DB 123, information required to search for a webpage based on search conditions received from the user terminal 2 is registered. More specifically, for example, a URL and search keywords are registered per webpage which is a search target. In addition, in the search DB 123, information which a conventionally known search engine requires to search for a webpage is registered.

Further, various programs are stored in the memory unit 12. More specifically, a predetermined OS (Operating System) and a WWW (World Wide Web) server program are stored. Further, in the memory unit 12, a tool bar install program distributed to the user terminal 2 is compressed and stored.

Furthermore, in the memory unit 12, various HTML (Hyper Text Markup Language) document and members (image data, audio data and movie data) are stored to generate a webpage transmitted to the user terminal 2. The webpage transmitted to the user terminal 2 is a search result page which displays user URLs of webpages searched based on search conditions, and download pages for downloading tool bar install programs.

The input/output interface 13 performs interface processing between the communication unit 11 and the memory unit 12, and the system control unit 14.

The system control unit 14 is configured to include, for example, a CPU (Central Processing Unit) 14a, a ROM (Read Only Memory) 14b and a RAM (Random Access Memory) 14c. Further, when the CPU 14a reads and executes various programs stored in the ROM 14b and the memory unit 12, the system control unit 14 functions as a receiving means, a counting means, a searching means, a URL specifying means, an evaluation rank determining means and an offering means.

In addition, the server 1 may be configured to include a plurality of server apparatus such as a server which manages various databases, a server which searches for webpages and a WWW server which offers various pieces of information.

[1.3. Configuration of User Terminal 2]

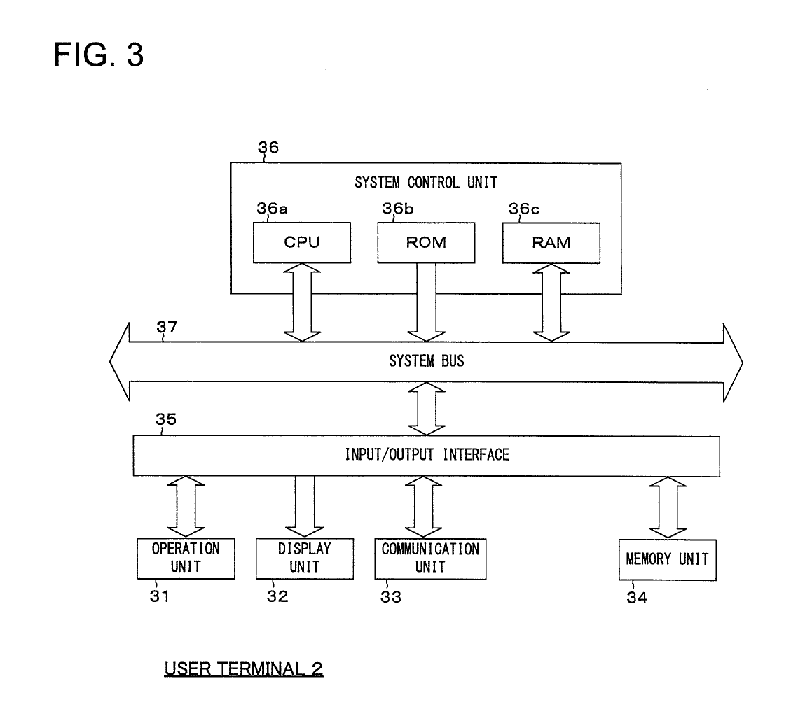

Next, a configuration of the user terminal 2 will be described using FIG. 3. In addition, for example, a personal computer, a PDA (Personal Digital Assistant) and a mobile telephone are applicable to the user terminals 2.

As illustrated in FIG. 3, the user terminal 2 has an operation unit 31, a display unit 32, a communication unit 33, a memory unit 34, an input/output interface 35 and a system control unit 36. Further, the system control unit 36 and the input/output interface 35 are connected through a system bus 37.

The operation unit 31 is configured to include, for example, a keyboard and a mouse, and receives an operation instruction from a user and outputs instruction content as an instruction signal to the system control unit 36.

The display unit 32 is configured to include, for example, a CRT (Cathode Ray Tube) display or a liquid crystal display, and displays information such as letters and images.

The communication unit 34 connects to the network NW, and controls a communication state with another device such as the server 1.

The memory unit 34 is configured to include, for example a hard disk drive.

Further, the memory unit 34 stores various programs. More specifically, a predetermined OS and a web browser are stored. Further, in the memory unit 34, a tool bar program received from the server 1 is stored.

The input/output interface 35 performs interface processing between the operation unit 31, the display unit 32, the communication unit 33 and the memory unit 34, and the system control unit 36.

The system control unit 36 is configured to include, for example, a CPU 36a, a ROM 36b and a RAM 36c. Further, when the CPU 36a reads and executes various programs stored in the ROM 36b and the memory unit 34, the system control unit 36 functions as a webpage display means, a reaction acquiring means, a URL acquiring means and a reaction transmitting means.

[1.4. Registration of Evaluation]

[1.4.1. Screen Example of User Terminal 2]

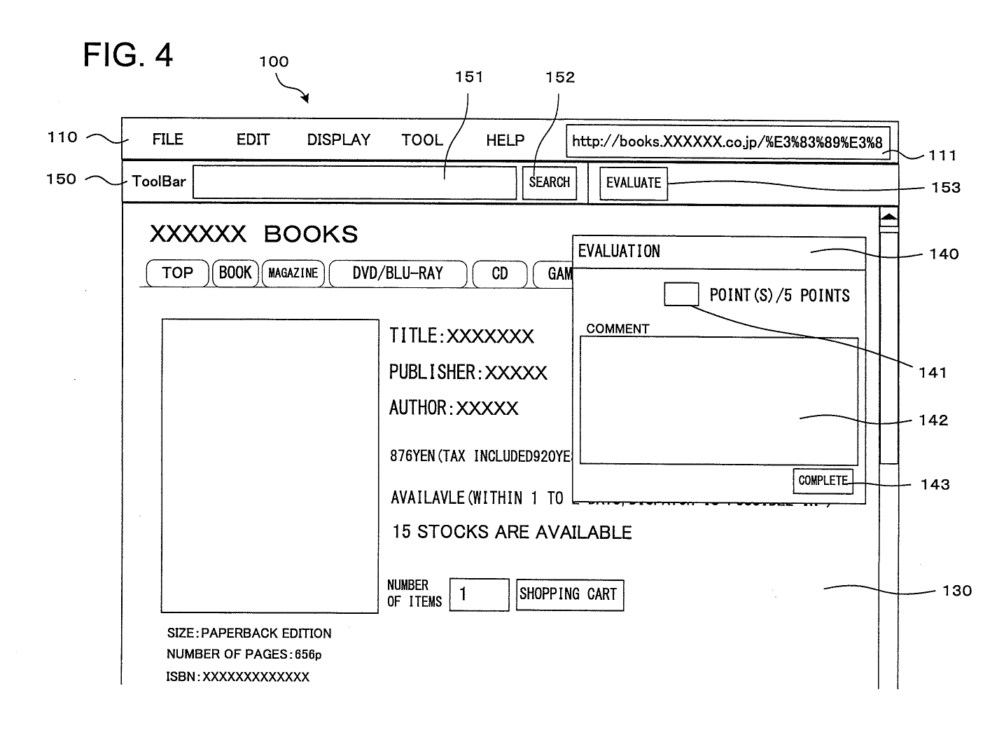

Next, a display example of the display unit 32 when a user evaluates a webpage will be described using FIG. 4.

A web browser 100 has a menu bar 110 and a tool bar 150, and has a webpage display area 130 which displays a read webpage. The menu bar 110 includes various buttons such as buttons for making various settings related to a web browser and buttons for using functions of the web browser. Further, the menu bar 110 includes an address display area 111 which displays a URL of a webpage displayed in the webpage display area 130.

The tool bar 150 includes a search condition input area 151 which receives an input of search conditions upon search for a webpage, and a search button 152 which needs to be pushed (clicked) when search is executed based on the search conditions inputted in the search condition input area 151. Further, the tool bar 150 includes an evaluation button 153 which needs to be pushed (clicked) when a webpage displayed on the webpage display area 130 is evaluated. When the user pushes (clicks) the evaluation button 153, an evaluation input form 140 is displayed in an area of the display unit 32.

The evaluation input form 140 is displayed as one function of the tool bar. The evaluation input form 140 includes an evaluation point input area 141 which receives an input of a numerical value for performing a 5 level evaluation on a webpage. The evaluation point input area 141 receives an input of one of numerical values “1”, “2”, “3”, “4” and “5”. When a numerical value other than these numerical values is inputted and a complete button 143 which will be described below is pushed (clicked), an error message is displayed. Further, the evaluation input form 140 includes an evaluation comment input area 142 which receives an input of an evaluation based on a comment on a webpage. Furthermore, the evaluation input form 140 includes the complete button 143 which needs to be pushed (clicked) when an input of evaluation is completed. When the complete button 143 is pushed (clicked), evaluations inputted in the evaluation point input area 141 and the evaluation comment input area 142 are transmitted to the server 1 as evaluation data in association with a URL of a webpage displayed in the webpage display area 130. In addition, a configuration may be employed where, as long as an evaluation is inputted to at least one of the evaluation point input area 141 and the evaluation comment input area 142, evaluation data is transmitted, or a configuration may be employed where, when evaluations are not inputted to both, evaluation data is not transmitted.

[1.4.2. Operation Example of Evaluation Information Utilizing System S]

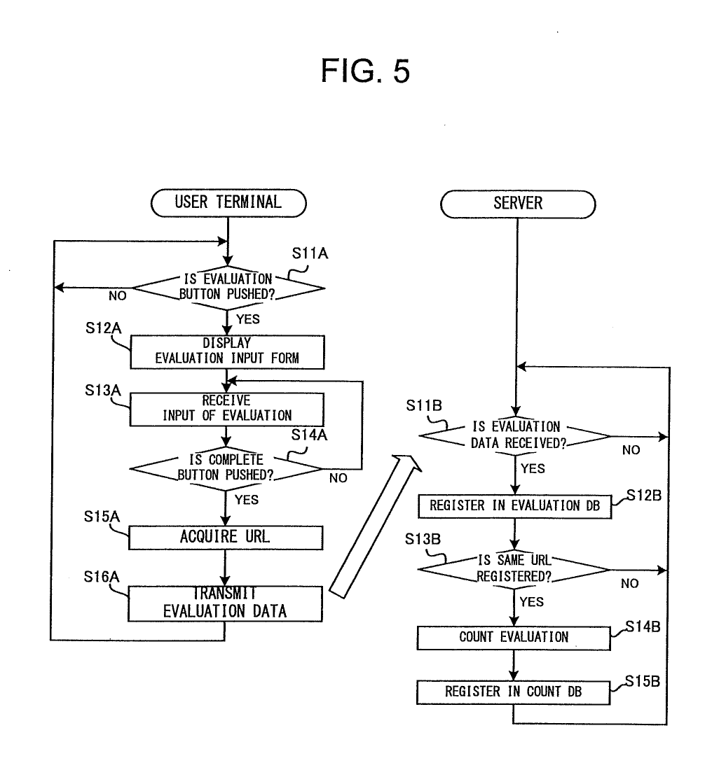

Next, an operation example of the evaluation information utilizing system S when a user evaluates a webpage will be described using FIG. 5.

As illustrated in FIG. 5, when a webpage is displayed in a portion of the webpage display area 130, the system control unit 36 of the user terminal 2 first decides whether or not the evaluation button 153 of the tool bar 150 is pushed (clicked) (step S11A). When deciding that the evaluation button 153 is not pushed (clicked) (step S11A: NO), the system control unit 36 stands by until the evaluation button 153 is pushed (clicked). Meanwhile, when deciding that the evaluation button 153 is pushed (clicked) (step S11A: YES), the system control unit 36 displays the evaluation input form 140 in one area of the display unit 32 (step S12A).

While the evaluation input form 140 is displayed, until the complete button 143 is pushed (clicked) (step S14A: YES), the system control unit 36 receives an input of evaluations in the evaluation point input area 141 and the evaluation comment input area 142 (step S13A and step S14A: NO).

When deciding that the complete button 143 is pushed (clicked) (step S14A: YES), the system control unit 36 acquires a URL of the webpage displayed in the webpage display area 130 (step S15A). Next, the system control unit 36 transmits to the server 1 evaluations inputted in the evaluation point input area 141 and the evaluation comment input area 142 and evaluation data associated with the URL acquired in processing in step S15A (step S16A), and returns to processing in step S11A.

Meanwhile, the system control unit 14 of the server 1 maintains a state for receiving the evaluation data from the user terminal 2 (step S11B: NO). Further, when receiving the evaluation data from the user terminal 2 (step S11B: YES), the system control unit 14 associates and registers the user's evaluation included in the evaluation data and the URL in the evaluation DB 121 (step S12B). In this case, when performing processing in step S12B, the system control unit 14 decides whether or not the same URL has already been registered in the evaluation DB 121 (step S13B).

When deciding that the same URL is not registered (step S13B: NO), the system control unit 14 returns to processing in step SUB. Meanwhile, when deciding that the same URL is registered (step S13B: YES), the system control unit 14 counts all evaluation points associated with the URL, and calculates the average value of the evaluation points (step S14B). Meanwhile, the calculated average value of the evaluation points indicates an average value of evaluation points of users for a webpage specified by the URL. Next, the system control unit 14 associates and registers the calculated average value of evaluation points, the number of evaluations and the URL in the count DB 122 (step S15B), and returns to processing in step S11B.

In addition, although the same user can input evaluations again and again when one webpage is displayed according to the flowchart illustrated in FIG. 5, restriction may be set to allow one user to evaluate one webpage only once.

[1.5. Utilization of Evaluation 1 (Webpage Search)]

[1.5.1. Screen Example of User Terminal 2]

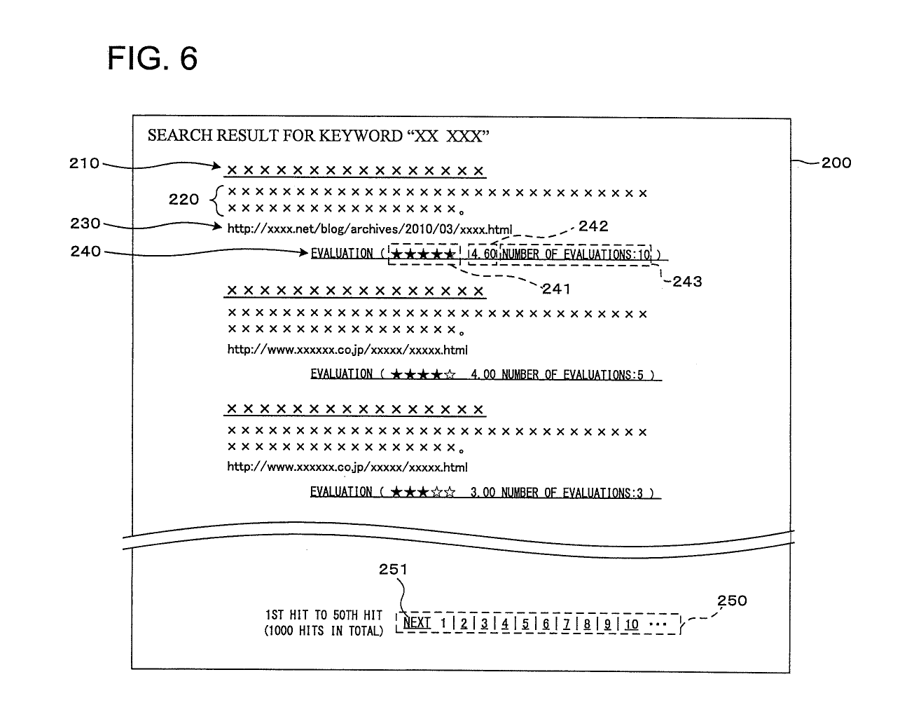

Next, a display example where the user inputs search conditions to the search condition input area 151 of the tool bar 150 and a search result is displayed on the display unit 32 will be described using FIG. 6. In addition, FIG. 6 is a view that illustrates a webpage 200 (“search result page 200”) indicating a search result displayed on the webpage display area 130.

As illustrated in FIG. 6, the search result page 200 displays a predetermined number (which can be arbitrarily selected by the user) of pieces of information related to a webpage per webpage searched by the server 1. The information related to the searched webpage is a title, content, a URL and an evaluation on the webpage which are displayed in a title display area 210, a content display area 220, a URL display area 230 and an evaluation display area 240.

The evaluation display area 240 includes an evaluation star display area 241 which shows the average value of evaluation points by filling stars, and an evaluation numerical value display area 242 which shows the average value by way of a numerical value. The average value of evaluation points displayed in the evaluation display area 240 is the average value of evaluation points registered in the count DB 122 in association with the URL displayed in the URL display area 230. Further, the evaluation display area 240 includes an evaluation number display area 243 which displays the number of users' evaluations on a webpage (the number of evaluations registered in the count DB 122).

The title display area 210 and the evaluation display area 240 are hyperlinks. When the title display area 210 is pushed (clicked), the webpage is displayed. When the evaluation display area 240 is pushed (clicked), a webpage (“evaluation list page”) is displayed which displays a list of users' evaluations (evaluation points and comments) on the webpage.

Further, the search result page 200 displays a search result link group 250. The search result link group 250 includes a plurality of links for transitioning to a search result page which displays a webpage different from the webpage displayed in the current search result page 200 among webpages obtained as a search result. When, for example, a link indicating a page number is pushed (clicked), the webpage transitions to a search result page of the page number associated with the link. Further, when a next result link 251 displayed as “NEXT” is pushed (clicked), the currently displayed search result page transitions to the next search result page. When, for example, the current 1st hit to 50th hit are displayed, if the next result link 251 is selected, the search result page transitions to a search result page which displays the 51st hit to the 100th hit.

[1.5.2. Operation Example of Evaluation Information Utilizing System S]

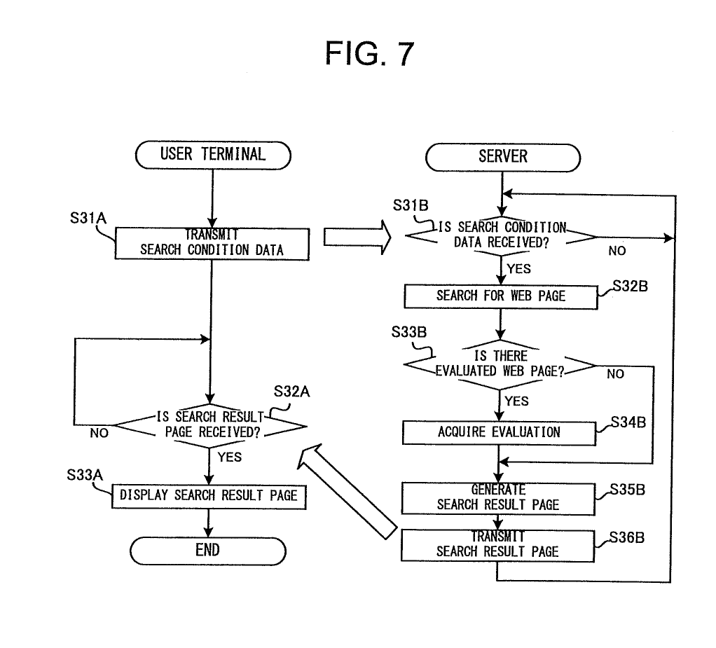

Next, an operation example of the evaluation information utilizing system S when the user searches for a webpage will be described using FIG. 7.

First, when detecting that the search button 152 of the tool bar 150 is pushed (clicked), the system control unit 36 of the user terminal 2 transmits to the server 1 search condition data including search conditions inputted in the search condition input area 151 (step S31A).

Meanwhile, the system control unit 14 of the server 1 maintains a state for receiving the search condition data from the user terminal 2 (step S31B: NO). Further, when receiving the search condition data from the user terminal 2 (step S31B: YES), the system control unit 14 refers to the search DB 123 and searches for the webpage matching the search conditions based on the search conditions included in the search condition data (step S32B). Next, the system control unit 14 decides whether or not there is an evaluated webpage among the webpages obtained as the search result in step S32B (step S33B). More specifically, the system control unit 14 decides whether or not the same URL as the URL of each webpage obtained as the search result is registered in the count DB 122.

When deciding that there is no evaluated webpage (step S33B: NO), the system control unit 14 proceeds to processing in step S35B. Meanwhile, when deciding that there is the evaluated webpage (step S33B: YES), the system control unit 14 acquires the average value of evaluation points and the number of evaluations from the count DB 122 based on the URL per evaluated webpage (step S34B), and proceeds to processing in step S35B.

Next, the system control unit 14 generates a search result page (step S35B). In this case, when acquiring, for example, the average value of evaluation points in processing in step S34B, the system control unit 14 places a display rank of the evaluated webpage at a high rank. Above all, a display rank of a webpage having a higher average value of evaluation points is placed at a higher rank. Next, the system control unit 14 transmits the generated search result page to the user terminal 2 (step S35B), and returns to processing in step S31B.

Meanwhile, the system control unit 36 of the user terminal 2 is in a standby state after transmitting search condition data in processing in step S31 (step S32A: NO), displays a search result page on the display unit 32 (step S33A) when receiving the search result page from the server 1 (step S32A), and finishes processing in the flowchart.

[1.6. Utilization of Evaluation 2 (Display of Evaluated Webpage)]

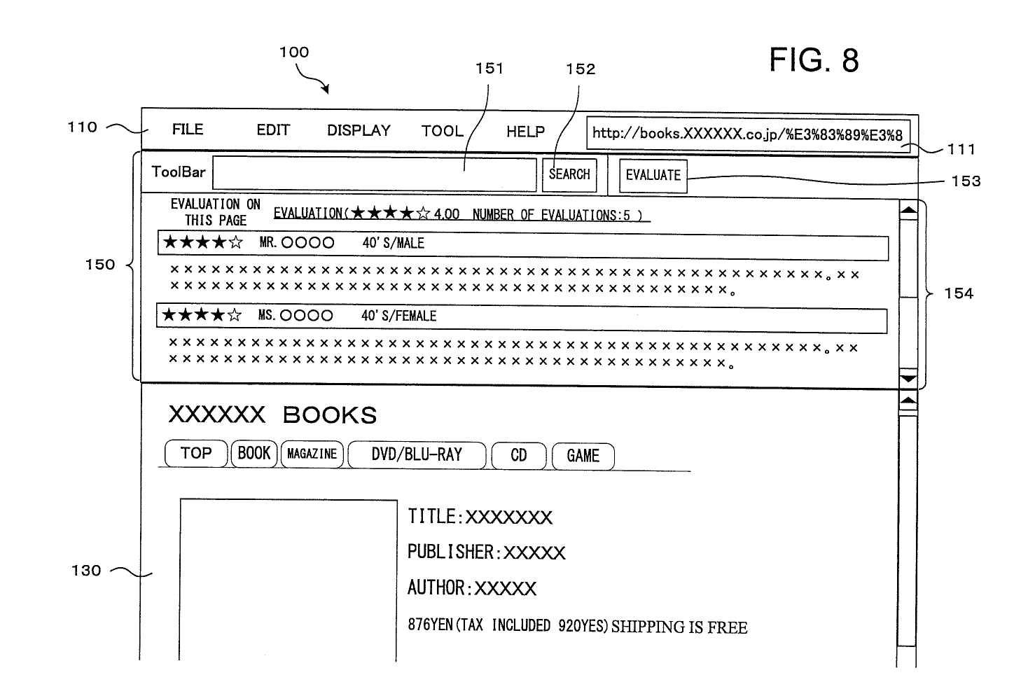

Next, a display example where an evaluated webpage is displayed on the display unit 32 will be described using FIG. 8.

As illustrated in FIG. 8, when an evaluated webpage evaluated by one user is displayed on the webpage display area 130, the tool bar 150 expands and the evaluation display area 154 is additionally provided in part of the tool bar 150. The evaluation display area 154 displays evaluations on a displayed webpage and the number of evaluations. More specifically, similar to the evaluation display area 240 in FIG. 6, the average value of evaluation points is displayed. Further, the evaluation display area 154 displays each user's evaluation comment on a displayed webpage and an evaluation point. In addition, an evaluation browsing button may be provided in the tool bar 150 instead of providing the evaluation display area 154, and an evaluation displayed in the evaluation display area 154 may be displayed in a webpage which is displayed when the evaluation browsing button is pushed (clicked).

### 2. Second Embodiment

Next, a second embodiment will be described. While an evaluation target is a webpage with the above first embodiment, a target of offer information offered by a webpage is an evaluation target with the following second embodiment. When, for example, there is a webpage which offers product information related to a product, a product is an evaluation target. A case will be described with the following second embodiment where a book is an evaluation target. In addition, a user's evaluation on a product in a webpage which offers product information related to a product is an example of “a reaction of a user related to offer information offered by a webpage”.

A server and a user terminal of an evaluation information utilizing system according to the second embodiment employ the substantially same configuration as the server 1 and the user terminals 2 of the evaluation information utilizing system S according to the first embodiment, and will not be partially described by assigning the same reference numerals to the same members and processings and differences will be mainly described.

[2.1. Outline of Function of Evaluation Information Utilizing System]

There are shopping sites which handle lots of books on Internet, and an identical book is handled by a plurality of shopping sites. For example, a book “A” is handled at a shopping site B and a shopping C in some cases. In this case, when a webpage targeting at the book “A” at the shopping site B is displayed, a server 1 according to the second embodiment acquires an evaluation on the book “A” of a user D from the tool bar 150. Further, when a user F displays a webpage targeting at the book “A” at the shopping site C, the server 1 presents the user D's evaluation on the book “A” through the tool bar 150. Thus, when the server 1 collects evaluations on an identical product at a plurality of different shopping sites and presents the evaluations to the user, the user does not need to search for and check a webpage targeting at the identical product at respective shopping sites when checking other users' evaluations on the product and can easily check the evaluations through the tool bar 150.

Further, the server 1 according to the second embodiment configures part of a shopping site G, and lists evaluations made on the book “A” while the webpage is displayed at the shopping site B and the shopping site C, in the webpage targeting at the book “A” at the shopping site G. By this means, the user can check evaluations made while the webpage is displayed at other shopping sites, from the webpage targeting at the book “A” at the shopping site G.

In order to realize this, the server 1 specifies a book which a webpage at each shopping site targets at, and attaches webpages targeting at an identical book. Hence, the server 1 needs to specify which book each webpage at each shopping site targets at. Therefore, the server 1 can specify a book from ISBN (International Standard Book Number) described in the URL or HTML document in each webpage. Further, when the ISBN cannot be specified from the URL or the HTML document, an ISBN input area for inputting an ISBN is provided in an evaluation input form to make the user input the ISBN therein. When the user inputs the ISBN once, by associating and registering the webpage and the ISBN in a DB at this point of time, it is possible to specify a book which this webpage targets at, so that it is not necessary to make the user input the ISBN again. Thus, if it is possible to specify based on the ISBN a book which a webpage targets at, it is possible to attach webpages at different shopping sites targeting at an identical book.

[2.2. Configuration of Server 1]

In a memory unit 12 according to the second embodiment, a book evaluation DB (an example of a “memory means”) and a book evaluation count DB are provided. In the book evaluation DB, a URL, an ISBN of a book which a corresponding webpage to a URL targets at and an evaluation are associated and registered. In addition, a 5 level evaluation according to the second embodiment is performed for a plurality of items (readability, impression after reading, recommendation level and cost performance). Hence, an evaluation point for each item is registered in the book evaluation DB. In the book evaluation count DB, the average value of evaluation points and the number of evaluations registered in the book evaluation DB are registered per ISBN. In addition, the average value of evaluation points is registered for each item.

Further, the memory unit 12 according to the second embodiment stores a plurality of book webpages which offer information targeting at a book. The book webpage displays book information (for example, a title, an author, a publisher, the size, the number of pages, the price and an ISBN) related to a target book. Further, when the target book is evaluated, the book webpage displays an each evaluator's (user's) evaluation registered in the book evaluation DB, and the average value of evaluation points and the number of evaluations registered in the book evaluation count DB. In addition, the book webpage can be generated by the server 1 and an apparatus which can access the book evaluation DB and the book evaluation count DB.

In the tool bar 150 according to the second embodiment, a book evaluation button may be further provided. When the book webpage is displayed, the user can evaluate a book by pushing (clicking) the book evaluation button.

[2.3. Registration of Evaluation: Operation Example of Evaluation Information Utilizing System S]

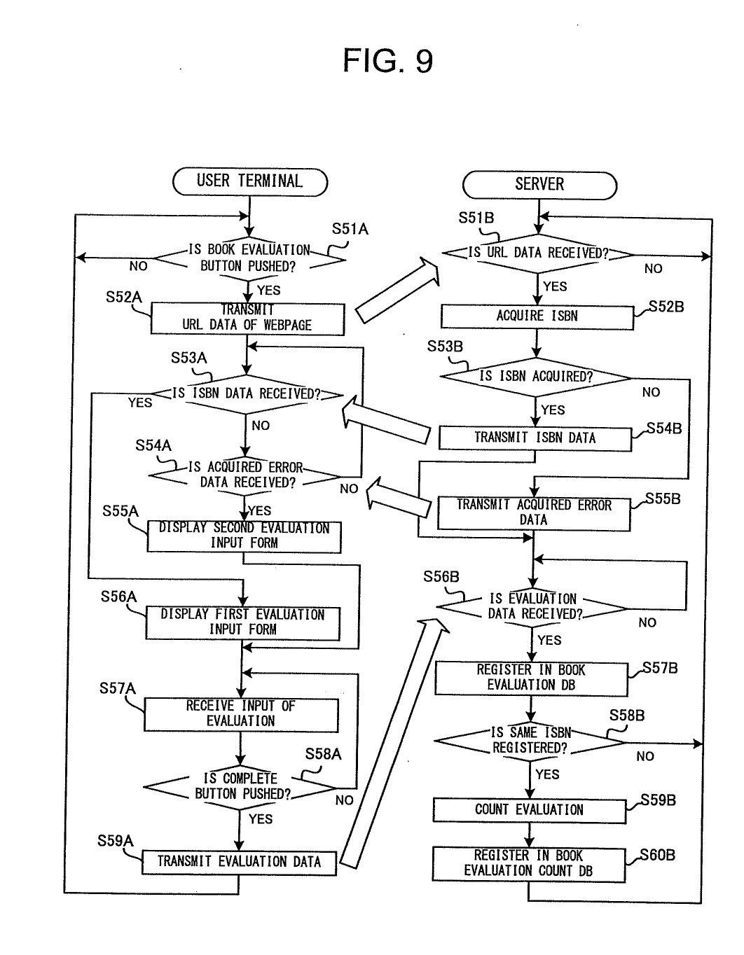

Next, an operation example of the evaluation information utilizing system S when a user evaluates a book which a webpage targets at will be described using FIG. 9.

As illustrated in FIG. 9, when a book webpage is displayed in a webpage display area 130, a system control unit 36 of the user terminal 2 decides whether or not the book evaluation button of the tool bar 150 is pushed (clicked) (step S51A). When deciding that the book evaluation button is pushed (clicked) (step S51A: YES), the system control unit 36 transmits to the server 1 URL data including a URL of a displayed webpage (step S52A).

Meanwhile, a system control unit 14 of the server 1 stands by until the URL data is received (step S51B: NO). Further, when receiving the URL data from the user terminal 2 (step S51B: YES), the system control unit 14 acquires an ISBN based on the URL included in the URL data (step S52B). More specifically, whether or not the ISBN is registered is checked by searching in the book evaluation DB based on the URL. When the ISBN is not registered, whether or not a character string indicating the ISBN is included is checked. Further, by acquiring the webpage based on the URL, whether or not a character string indicating the ISBN is included in HTML document in the acquired webpage is checked. In addition, by checking whether or not the character string indicating the ISBN is included in both of the URL and the HTML document, it is possible to more reliably acquire the ISBN.

Next, the system control unit 14 decides whether or not the ISBN can be acquired in processing in step S52B (step S53B). The system control unit 14 transmits ISBN data including the ISBN to the user terminal 2 (step S54B) when deciding that the ISBN can be acquired (step S53B: YES), and transmits acquisition error data indicating that the ISBN cannot be acquired, to the user terminal 2 (step S55B) when deciding that the ISBN cannot be acquired (step S53B: NO).

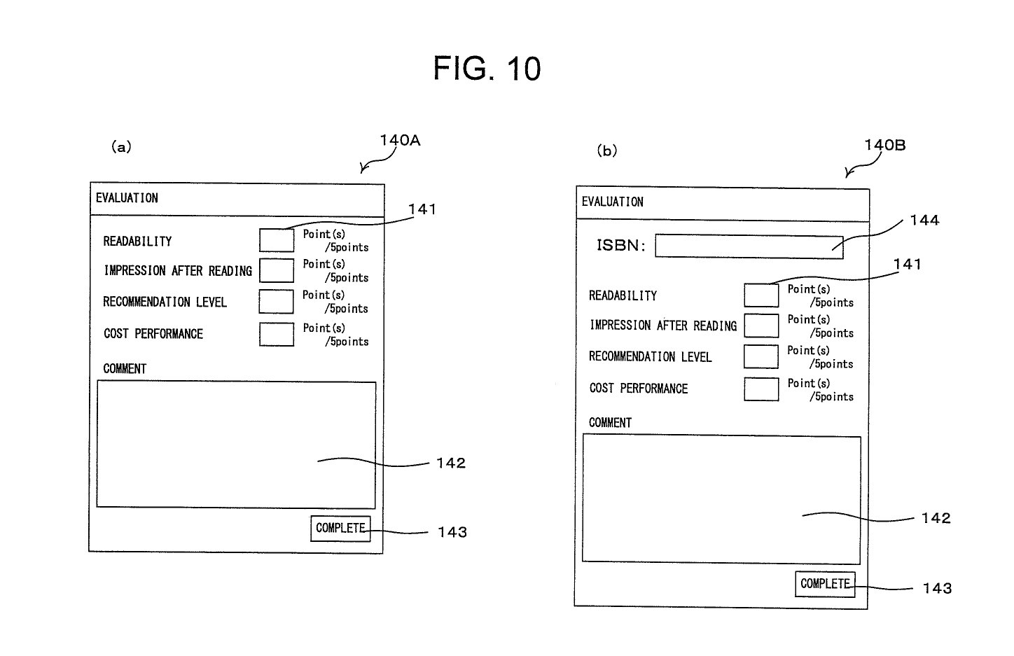

Meanwhile, the system control unit 36 of the user terminal 2 stands by until the ISBN data or the acquisition error data is received (step S53A: NO and step S54A: NO) after processing in step S52A, and, when receiving the ISBN data (step S53A: YES), displays a first evaluation input form 140A illustrated in FIG. 10(a) in one portion of the display unit 32 (step S56A). Meanwhile, when receiving the acquisition error data (step S54A: YES), the system control unit 36 displays a second evaluation input form 140B illustrated in FIG. 10(b) in one portion of the display unit 32 (step S55A).

Meanwhile, the first evaluation input form 140A and the second evaluation input form 140B will be described using FIG. 10. FIG. 10(a) is a view that illustrates an example of a first evaluation input form, and FIG. 10(b) is a view that illustrates an example of a second evaluation input form. As illustrated in FIG. 10(a), in the first evaluation input form 140A, an evaluation point input area 141 for a plurality of items (readability, impression after reading, recommendation level and cost performance) is provided. Meanwhile, as illustrated in FIG. 10(b), in the second evaluation input form 140B, an ISBN input area 144 which receives an input of an ISBN is provided. The second evaluation input form 140B can specify an evaluation target book when the user inputs the ISBN.

Back to FIG. 9, while the first evaluation input form 140A or the second evaluation input form 140B is displayed, until the complete button 143 is pushed (clicked) (step S58A: YES), the system control unit 36 receives an input of an evaluation in the evaluation point input area 141, the evaluation comment input area 142 and the ISBN input area 144 (only when the second evaluation input form 140B is displayed) (step S57A and step S58A: NO).

When deciding that the complete button 143 is pushed (clicked) (step S58A: YES), the system control unit 36 transmits to the server 1 evaluation data generated in association with a URL, an ISBN, an evaluation inputted in the evaluation point input area 141 and an evaluation inputted in the evaluation comment input area 142 of a webpage displayed in the webpage display area 130 (step S59A), and returns to processing in step S51A.

Meanwhile, the system control unit 14 of the server 1 stands by until evaluation data is received after processing in step S54B or processing in step S55B (step S56B: NO). Further, when receiving the evaluation data from the user terminal 2 (step S56B: YES), the system control unit 14 associates and registers the URL, the ISBN and the user's evaluation included in the evaluation data, in the book evaluation DB (step S57B). Next, when performing processing in step S57B, the system control unit 14 decides whether or not the same ISBN has already been registered in the book evaluation DB (step S58B).

When deciding that the same ISBN is not registered (step S58B: NO), the system control unit 14 returns to processing in step S51B. Meanwhile, when deciding that the same ISBN is registered (step S58B: YES), the system control unit 14 counts evaluation points related to each item associated with the ISBN and calculates the average value of the evaluation points (step S59B). Next, the system control unit 14 associates and registers the calculated average value of the evaluation points and the number of evaluations, and the ISBN in the book evaluation count DB (step S60B), and returns processing in step S51B.

[2.4. Utilization of Evaluation 1]

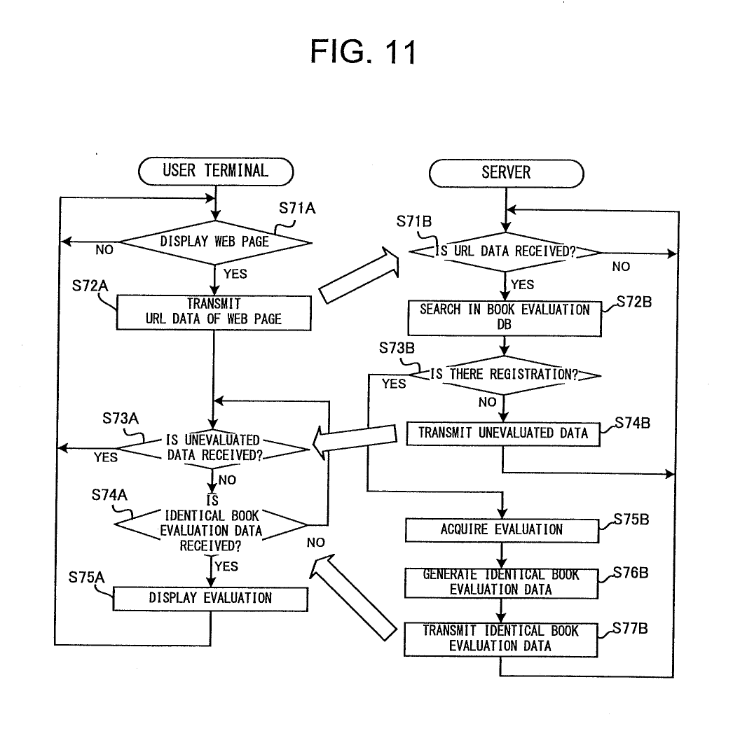

Next, an operation example of the evaluation information utilizing system S when a book webpage targeting a book evaluated by a user is displayed in the display unit 32 will be described using FIG. 11.

As illustrated in FIG. 11, the system control unit 36 of the user terminal 2 decides whether or not the webpage is newly displayed in the webpage display area 130 (step S71A) while the web browser is activated and, when deciding that the webpage is newly displayed in the webpage display area 130 (step S71A: YES), transmits to the server 1 URL data including the URL of this webpage (step S72A).

Meanwhile, the system control unit 14 of the server 1 stands by until the URL data is received (step S71B: NO). When receiving the URL data from the user terminal 2 (step S71B: YES), the system control unit 14 searches in the book evaluation DB based on the URL included in the URL data (step S72B). Next, the system control unit 14 decides whether or not the URL included in the URL data is registered in the book evaluation DB (step S73B). In this case, when deciding that the URL is not registered (step S73B: NO), the system control unit 14 transmits to the user terminal 2 unevaluated data indicating that the URL is not registered in the book evaluation DB. Meanwhile, when deciding that the URL is registered (step S73B: YES), the system control unit 14 acquires an ISBN and an evaluation from the book evaluation DB and acquires the average value of evaluation points and the number of evaluations registered in the book evaluation count DB based on the acquired ISBN (step S75B).

Next, the system control unit 14 generates the identical book evaluation data based on the evaluation acquired in processing in step S75B (step S76B). The identical book evaluation data is data for presenting various pieces of information related to the evaluation acquired in processing in step S75B, to the user through the tool bar 150. As illustrated in, for example, FIG. 8, the identical book evaluation data is data for displaying an evaluation in an evaluation display area 154 of the tool bar 150 (the average value of evaluation points of each item, the number of evaluations, an evaluation comment per evaluator (user) and evaluation points for each item). Next, the system control unit 14 transmits the generated identical book evaluation data to the user terminal 2 (step S77B), and returns to processing in step S71B.

Meanwhile, the system control unit 36 of the user terminal 2 stands by until unevaluated data or identical book evaluation data is received (step S73A: NO and step S74A: NO) after processing in step S72A, and, when receiving the unevaluated data (step S73A: YES), returns to processing in step S71A. Meanwhile, when receiving the identical book evaluation data (step S74A: YES), the system control unit 36 displays an evaluation on a book in the evaluation display area 154 of the tool bar 150 based on various pieces of information related to the evaluation included in the identical book evaluation data (step S75A), and returns to processing in step S71A.

In addition, a webpage targeting at a book according to the second embodiment is not limited to a webpage at a shopping site, and may be webpages (for example, review pages of newspaper companies) at other than shopping sites.

Further, although a case has been described with the second embodiment where a product is a book, the present invention is applicable to other products. In this case, it is possible to utilize a product identification code such as a JAN code instead of an ISBN. Further, when a product other than a book is evaluated, evaluation items displayed in an evaluation input form are preferably changed according to a genre to which this product belongs. When, for example, the product belongs to a television genre, the product is evaluated as to items such as design, image quality, sound quality, operability and functionality. In this case, the system control unit 14 (an example of an “item defining means”) specifies the genre to which the product belongs based on a URL or information such as a title and a META tag of the webpage acquired based on the URL. By this means, user's 5 level evaluation items can be defined without bothering the user. In addition, when the genre cannot be specified, it may be possible to make the user select a genre to which the product belongs.

[2.5. Utilization of Evaluation 2]

Next, a case will be described where an evaluation is utilized by listing in a book webpage an evaluation registered in the book evaluation DB. The system control unit 14 (an example of a “webpage generating means” and an “acquiring means”) of the server 1 acquires an evaluation registered in association with an ISBN of a book “A” from the book evaluation DB and lists the evaluation in the book webpage upon generation of the book webpage which offers information related to the book “A”. By this means, it is possible to include the evaluation on the book “A” in the webpage which offers offer information related to the same book “A”, in the webpage of a local site which offers offer information related to the book “A”. Consequently, the user can check an evaluation on the book “A” in various webpages through one webpage.

As described above, the system control unit 14 of the server 1 according to each of the above embodiments receives a user's evaluation related to offer information offered by a webpage and a URL of the webpage from the user terminal 2, associates and registers the received user's evaluation and URL in the evaluation DB 121 and counts users' evaluations registered in the evaluation DB 121 per URL. That is, the user can evaluate offer information offered by a webpage.

Further, the system control unit 14 of the server 1 according to the first embodiment receives search conditions transmitted from the user terminal 2, searches for a webpage which satisfies the search conditions, specifies a URL registered in the evaluation DB 121 from URLs of the searched webpages, determines a display rank based on the users' evaluations counted for the specified URL and transmits to the user terminal 2 the search result page which displays the URL of the searched webpage according to the display rank. By this means, the user who has searched for the webpage can check the URL of the searched webpage according to an order based on users' evaluations.

In addition, part of offer information offered by a webpage may be an evaluation target. More specifically, image files, movie files and document files offered by webpages may be evaluation targets. Further, when one webpage lists a plurality of articles, part of articles may be evaluated. In this case, it is necessary to make the user specify an evaluation target. Hence, an “evaluation” item is provided in a so-called right click menu (a menu displayed when right clicking is performed). Further, when the “evaluation” item of the right click menu is selected in a state where one offer information is specified, an evaluation input form for evaluating the specified offer information is displayed. An evaluation inputted from the evaluation input form is associated with a URL of a webpage and information for specifying offer information specified by a user, and is transmitted to the server 1 as evaluation data. The server 1 associates and registers the user's evaluation, and the URL of the webpage and information for specifying the offer information specified by the user in a DB. Thus, it is possible to make every offer information offered by a webpage an evaluation target. In addition, the user's evaluation on part of offer information offered by the webpage is an example of “a reaction of a user related to offer information offered by a webpage”.

Further, although embodiments have been described with the above embodiments where a tool bar of adding a function related to an evaluation on a webpage is used for an existing browser, a webpage evaluation application which has a function related to an evaluation on a webpage may be used.

Further, it may be possible to inquire to a user as to use of an evaluation inputted by the user (“an evaluation inputted by the user may be used for search” or “content of an evaluation inputted by the user may be disclosed as a user review”). This inquiry may be performed when, for example, a tool bar program is installed or an evaluation is transmitted. Further, it may be possible to adequately enable the user to allow or not to allow use of an evaluation through an option setting of the tool bar program.

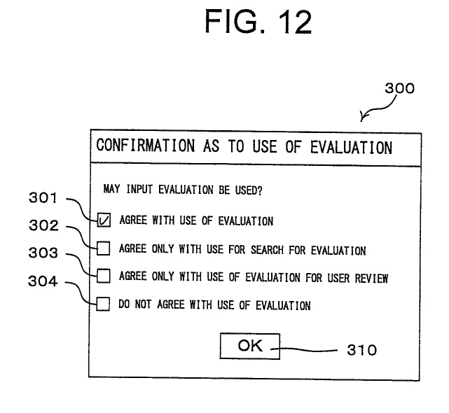

In addition, when this inquiry is performed upon installing of the tool bar program, if an operation of installing the tool bar program is detected, an inquiry form for allowing the user to select whether or not to allow use of an evaluation is displayed on a display unit 21 of the user terminal 2. Hereinafter, an inquiry form 300 will be described using FIG. 12. The inquiry form 300 is provided with (1) a check box 301 corresponding to “agree with use of evaluation”, (2) a check box 302 corresponding to “agree only with use for search for evaluation”, (3) a check box 303 corresponding to “agree only with use of evaluation for user review and (4) a check box 304 corresponding to “do not agree with use of evaluation”. The user can respond to confirmation as to use of an evaluation by checking one of check boxes and clicking an OK button 310.

Further, in case that the above inquiry is made upon transmission of an evaluation according to the first embodiment, for example, the system control unit 36 displays the inquiry form 300 when deciding in step S11A in FIG. 5 that an evaluation button 153 is pushed (clicked) (step S11A: YES) or when deciding that in step S14A in FIG. 5 that a complete button 143 is pushed (clicked) (step S14A: YES). In this case, the system control unit 36 can transmit evaluation use permission information indicating content inputted in the inquiry form 300 (user's response content related to use of an evaluation) together with evaluation data in processing in step S16. Meanwhile, the system control unit 14 of the server 1 receives a response to the inquiry together with the evaluation data from the user terminal 2 in step S11B (the system control unit 14 functions as a response receiving means), associates and registers the user's evaluation, the URL and the evaluation use permission information in the evaluation DB 121 in processing in step S12B, and does not use the user's evaluation for an item for which the evaluation use permission information indicates “not permitted”.

Similarly, in case that the above inquiry is made upon transmission of an evaluation according to the second embodiment, for example, the system control unit 36 displays the inquiry form 300 when deciding in step S51A in FIG. 9 that a book evaluation button is pushed (clicked) (step S51A: YES) or when deciding in step S58A in FIG. 9 that the complete button 143 is pushed (clicked) (step S58A: YES). In this case, the system control unit 36 can transmit evaluation use permission information indicating content inputted in the inquiry form 300 (user's response content related to use of an evaluation) together with evaluation data in processing in step S59A. Meanwhile, the system control unit 14 of the server 1 receives a response to the inquiry together with the evaluation data from the user terminal 2 in step S56B (the system control unit 14 functions as a response receiving means), associates and registers the user's evaluation, the URL and the evaluation use permission information in the book evaluation DB in processing in step S57B, and does not use the user's evaluation for an item for which the evaluation use permission information indicates “not permitted”.

The present invention is by no means limited to the above embodiments. The above embodiments are exemplary embodiments, and employ the substantially same configuration as the technical idea recited in the claims of the present invention, and the configuration exhibiting the same function effect is included in the technical range of the present invention.

### EXPLANATION OF REFERENCE NUMERALS

1 SERVER
11 COMMUNICATION UNIT
12 MEMORY UNIT
13 INPUT/OUTPUT INTERFACE
14 SYSTEM CONTROL UNIT
15 SYSTEM BUS
2 USER TERMINAL
31 OPERATION UNIT
32 DISPLAY UNIT
33 COMMUNICATION UNIT
34 MEMORY UNIT
35 INPUT/OUTPUT INTERFACE
36 SYSTEM CONTROL UNIT
37 SYSTEM BUS
NW NETWORK
S EVALUATION INFORMATION UTILIZING SYSTEM

1-14. (canceled)

15. A server apparatus that counts an evaluation of a user on a product for which offer information related to the product is offered in a plurality of different webpages, the server apparatus comprising:
a receiving unit that receives the evaluation of the user on the product for which the offer information is offered in a webpage and a URL of the webpage, from a terminal device that receives an input of the evaluation of the user;
a storage control unit that controls a memory unit to associate and store the evaluation of the user received by the receiving unit and the URL;
an associating unit that associates the URL stored in the memory unit and a URL of a webpage targeting at an identical product;
a counting unit that counts the evaluation of the user stored in the memory unit per product, based on the URL associated by the associating unit; and
a counting result data transmitting unit that, when a terminal device displays a webpage which displays the product, transmits to the terminal device counting result data for displaying on the terminal device a counting result counted for the product by the counting unit.

16. The server apparatus according to claim 15, wherein the associating unit associates the URL based on an identifier of the product included in HTML document or the URL of the webpage.

17. The server apparatus according to claim 16, wherein the identifier is an ISBN or a JAN code.

18. The server apparatus according to claim 15, further comprising an identifier input screen data transmitting unit that, when the identifier of the product is not included in HTML document or the URL of the webpage, transmits to the terminal device identifier input screen data for displaying on a display unit of the terminal device which the user uses to input an evaluation an identifier input screen for making the user input an identifier of a target product in the webpage.

19. The server apparatus according to claim 15, further comprising:
a specifying unit that specifies an identifier of a product described in the URL received by the receiving unit; and
an evaluation input screen data transmitting unit that, when the specifying unit cannot specify the identifier of the product, transmits evaluation input screen data for displaying an evaluation input screen for inputting the evaluation of the user in a display unit of a terminal device which is a transmission source of the URL.

20. The server apparatus according to claim 19, wherein the evaluation input screen comprises an area in which the identifier of the product can be inputted.

21. The server apparatus according to claim 20, further comprising an area in which one of an evaluation based on a comment and a multilevel evaluation can be inputted.

22. The server apparatus according to claim 21, wherein the multilevel evaluation is an evaluation on a plurality of items defined based on the offer information.

23. The server apparatus according to claim 15, wherein
the receiving unit further receives one of the URL of the webpage read by the terminal device and a META tag described in the webpage, and
the server apparatus further comprises an item defining unit that specifies a genre to which a target product of offer information offered by the webpage belongs, based on at least one of the URL or the META tag received by the receiving unit, and defines the plurality of items based on the specified genre.

24. The server apparatus according to claim 15, wherein
a tool bar program of acquiring the evaluation of the user and the URL of the webpage and associating and transmitting the evaluation and the URL is installed in the terminal device which receives an input of the evaluation of the user, and
the receiving unit receives the evaluation of the user and the URL of the webpage which are transmitted by the tool bar program.

25. A non-transitory recording medium having a computer-readable information processing program causing a computer included in a server apparatus that counts an evaluation of a user on a product for which offer information related to the product is offered in a plurality of different webpages, the server apparatus comprising:
a receiving unit that receives the evaluation of the user on the product for which the offer information is offered in a webpage and a URL of the webpage, from a terminal device that receives an input of the evaluation of the user;
a storage control unit that controls a memory unit to associate and store the evaluation of the user received by the receiving unit and the URL;
an associating unit that associates the URL stored in the memory unit and a URL of a webpage targeting at an identical product;
a counting unit that counts the evaluation of the user stored in the memory unit per URL, based on the URL associated by the associating unit; and
a counting result data transmitting unit that, when a terminal device displays a webpage which displays the product, transmits to the terminal device counting result data for displaying on the terminal device a counting result counted for the product by the counting unit.

26. A terminal device that is connected to a server apparatus that counts an evaluation of a user on a product for which offer information related to the product is offered in a plurality of different webpages, and which comprises:
a receiving unit that receives the evaluation of the user on the product for which the offer information is offered in a webpage and a URL of the webpage, from a terminal device that receives an input of the evaluation of the user;
a storage control unit that controls a memory unit to associate and store the evaluation of the user received by the receiving unit and the URL;
an associating unit that associates the URL stored in the memory unit and a URL of a webpage targeting at an identical product;
a counting unit that counts the evaluation of the user stored in the memory unit per product, based on the URL associated by the associating unit; and
a counting result data transmitting unit that, when a terminal device displays a webpage which displays the product, transmits to the terminal device counting result data for displaying on the terminal device a counting result counted for the product by the counting unit, the terminal device comprising:
a transmitting unit that, when receiving an input of the evaluation of the user, transmits the evaluation of the user and the URL of the webpage to the server apparatus; and
a display control unit that displays counting result data received from the server apparatus, on a display unit.

27. An evaluation counting system comprising: a terminal device; and a server apparatus that counts an evaluation of the user on a product for which offer information related to the product is offered in a plurality of different webpages, wherein
the server apparatus comprises:
a receiving unit that receives the evaluation of the user on the product for which the offer information is offered in a webpage and a URL of the webpage, from a terminal device that receives an input of the evaluation of the user;
a storage control unit that controls a memory unit to associate and store the evaluation of the user received by the receiving unit and the URL;
an associating unit that associates the URL stored in the memory unit and a URL of a webpage targeting at an identical product;
a counting unit that counts the evaluation of the user stored in the memory unit per product, based on the URL associated by the associating unit; and
a counting result data transmitting unit that, when a terminal device displays a webpage which displays the product, transmits to the terminal device counting result data for displaying on the terminal device a counting result counted for the product by the counting unit, and
the terminal device comprises:
a transmitting unit that, when receiving an input of the evaluation of the user, transmits the evaluation of the user and the URL of the webpage to the server apparatus; and
a display control unit that displays counting result data received from the server apparatus, on a display unit.
